(19) United States
(12) Patent Application Publication
(10) Pub. No.: US 2007/0285209 A1
(43) Pub. Date: Dec. 13, 2007

(54) Systems and Methods for Controlling Vehicle Access

(76) Inventors: Karl Heusi, Mettmenstetten (CH); Rolf Fischer, Horw (CH); Stephan Egli, Galgenen (CH)

Correspondence Address: FISH & ASSOCIATES, PC;ROBERT D. FISH, 2603 Main Street, Suite 1050, Irvine, CA, 92614-6232, US

(21) Appl. No.: 11/737,486

(22) Filed: Apr. 19, 2007

(30) Foreign Application Priority Data
Apr. 19, 2006 (EP) 06112784.1

(51) Int. Cl. G05B 19/00; G08C 19/00

(52) U.S. Cl. 340/5.23; 340/825.28; 705/5; 340/5.1; 340/5.2; 705/5

(57) ABSTRACT

Contemplated systems and methods for automated and controlled vehicle access comprise a vehicle associated reader that informationally cooperates with a reservation system at which a user places a reservation. At the vehicle, the reader automatically retrieves a unique information code from the user (e.g., in form of an RFID signal) and is transferred to and compared with an entry in the reservation system. Upon validation, access is granted to already known users, most preferably in combination with a further validation step (e.g., via keypad). Users with previously unknown unique information code are issued a temporary code by the reservation system, and upon validation of the temporary code and automatic retrieval of the unique information code, the reservation database is updated such that the unique information code replaces the temporary code. Preferably, access is then granted upon further validation step.

This application claims the priority of our copending European patent application with the serial number EP 06112784.1, filed Apr. 19, 2006, and which is incorporated by reference herein.

### FIELD OF THE INVENTION

The invention relates to an automated controlled access systems and methods, especially as it relates to automated vehicle access systems.

### BACKGROUND OF THE INVENTION

Numerous systems for shared-use of vehicles have been previously described, however, presently known systems are inconvenient because only a limited group of persons has access to the vehicles, such as cars. Using a shared vehicle must be as convenient as possible to gain a large market penetration, or users will choose to use private vehicles instead. Thus, the shared vehicles should be accessible for a large group of persons.

For example, vehicles should be easily accessible for persons not belonging to a closed user group. The vehicles should in particular also be accessible for persons using a shared vehicle for the first time. Third party organizations like trusted partner organizations or travel agencies should be able to allocate shared-use vehicles all over the world without the need of annoying inscription procedures to gain access to a shared-used vehicle. Transaction time and the number of steps that are required to gain entry to the vehicle should also be minimized. There is a need for a reservation system which can enable efficient use of vehicles and helps ensure availability. The reservation system should enable also various third party providers to easily select an available vehicle and time for a user, or to allow choosing from alternatives that are similar to the desired vehicle and time. Access to vehicles should be secure from unauthorized users. During the period the car is reserved, access to the car should be restricted to the reserving user only. This provides an expected level of security for the reserving user and prevents a vehicle from being used by a person with no reservation either maliciously or inadvertently. Unfortunately, these desirable advantages have not been realized with the heretofore known systems and methods.

Several systems have been described for shared access or shared-use vehicles. Generally these systems describe various methods of access and monitoring vehicles and are not integrated with a plurality of reservation systems. As such, they typically provide ways of sharing vehicles within one user group, and are therefore not very scalable. Patent application No. WO 01/61604 discloses a system which can be used within a single reservation system only. Patent application No. WO 02/089077 discloses a system which is generally unsuitable for a system of shared-use vehicles, when fast vehicle access is important.

It is therefore an object of the present invention to provide a system that allows a number of shared-use vehicles to be easily used by a huge potential number of users. It is also an object to provide a system that is able to improve the average utilization of shared-use vehicles, by offering the shared-use vehicles to a larger user group or to third parties such as a trusted partner organization. It is also an object to provide a system which is able to use shared-use vehicles of a partner organization for own clients. It is a further object of the invention to provide a shared-use vehicle system that is convenient for use. It is an additional object to provide a system that makes construction, management, and growth of a shared-use vehicle system more economical.

### SUMMARY OF THE INVENTION

These and other objects are attained by the invention, which comprises a system and method for sharing the use of one or more vehicles by a plurality of users. The problem is in particular solved by a system for controlling access to a vehicle, comprising:

a vehicle-associated access control module for enabling access to the vehicle by a first or second authorized user following completion of a verification sequence, the vehicle-associated access control module comprising a reader for reading a provided unique information code (PUIC);

a server including a verification module for making a reservation for the vehicle upon receiving a request to reserve the vehicle and including storage means for storing a unique information code (UIC) and a personal identification code (PIC) of the first and second authorized user;

a communications channel for supporting communications between the vehicle-associated access control module and the server,

whereby the vehicle-associated access control module comprises storage means for storing information representative of the reservation, and comprises a decision module which is adapted to enable access to the vehicle,

the decision module is adapted to read by reader a provided unique identification code (PUIC):

the decision module is adapted to check whether a unique identification code (UIC) of the first authorized user is stored, and either:

permits vehicle access to the first authorized user if the provided unique identification code (PUIC) corresponds to the unique identification code (UIC) of the first authorized user,

or is adapted to read by input means a provided personal identification code (PPIC) and permits access if the provided personal identification code (PPIC) corresponds to the personal identification code (PIC) of the first authorized user, whereby the decision module transmits the provided unique identification code (PUIC) by the communication channel to the server, wherein the provided unique identification code (PUIC) is stored in the storage means as the unique identification code (UIC) of the first authorized user.

The problem is in particular also solved by a method of controlling access to a vehicle by a first or second authorized user, characterized in that the method comprises:

making, at a reservation system, a reservation for the vehicle, upon receiving a request by the first authorized user to reserve the vehicle, wherein the reservation system stores information of authorized users;

checking whether information of authorized users comprise a unique identification code (UIC) of the first authorized user and if not transmitting a personal identification code (PIC) to the first authorized user; and

when the first authorized user attempts to access to the vehicle by providing a unique identification code (PUIC),

either permitting access if the provided unique identification code (PUIC) corresponds to the unique identification code (UIC) of the first authorized user,

or collecting the data of the provided unique identification code (PUIC) and updating the stored information of the first authorized user in the reservation system by storing the collected data as the unique identification code (UIC), and permitting access if the first authorized user provides a personal identification code (PPIC) corresponding to the transmitted personal identification code (PIC).

According to the present invention, a system for controlling access to a vehicle is provided. The system includes a vehicle associated access control module that is located in the vehicle. This module allows access to the vehicle by users who have been authorized by a verification module. The system also includes a central server and the verification module being part of the central server. The central server communicates with the vehicle-associated access control module over a communications such as a wireless communications system. The central server preferably includes storage means that stores personal identification information for all authorized users, and vehicle information. It is further preferred that the server has a database that stores all reservation requests, including specific vehicles, dates and times, and authorizations.

To be able to get access to a vehicle, three requirements have to be fulfilled: First: The user has to become an authorized user before he can make a reservation for a vehicle. Second: The authorized user has to make a reservation for a specific vehicle at a certain location, date and time. Third: The authorized user needs an identification when, at the appointed time, the authorized user accesses the vehicle and presents identification such as a smart card comprising a unique identification code (UIC) or a personal identification code (PIC) to gain access to the vehicle. Most typically, to become an authorized user, legal criteria such as owing a drivers license as well as credit criteria have to be fulfilled. These criteria are preferably checked only once. If the check succeeds, the user becomes the status of an authorized user.

Preferably, each authorized user is provided with a personal code (PC) as well, and of each authorized user his unique information code (UIC) is known. Preferably this unique information code (UIC) is unique worldwide. Such a unique information code (UIC) has the advantage that its use is safe, and the user can always be identified.

There are several unique information codes (UIC) known. For example Fingerprint or Iris-/Retina-Scan prove to be a unique information code (UIC). Another approach is using a widely distributed personal electronic means already in the possession of the users for other applications to provide a unique information code. Said electronic means can for example be a general-purpose smart card or a credit card equipped with a chip card for instance. Such cards are herein called smart cards. Each smart card has a world wide unique information code (UIC), called ID-code, which definition and readability is defined by ISO standards No. 14443 and 15693. One advantage of using the ID-code is that this code is always accessible for a reader, in contrast to other data stored on the smart card, which may be access protected or stored in an unknown or unreadable format. Therefore a database can be established comprising an individual personal code (PC), assigned to each user, as well as the unique information code (UIC) of the corresponding user. One disadvantage of the unique information codes (UIC) mentioned in this chapter is that it is often unknown to the user and can therefore not be provided by the user himself. It is therefore necessary to establish a link between a specific user, represented by the individual personal code (PC) and his unique ID-code. This link is preferably established by reading the ID-code when knowing that the specific user is presenting his smart card, and to store the corresponding unique identification code (UIC), which in this example is the respective ID-code. This information is usually stored in a database. To make sure that the specific user and no other person is presenting his smart card, which is read, for example a personal identification code (PPIC) may be used, which the specific user has to provide before or after reading the smart card. Only if this provided personal identification code (PPIC) corresponds to the personal identification code (PIC) expected from the specific user, the unique identification code (UIC) is assigned to the personal code (PC) and stored.

Once the link between a user, represented by the personal code (PC) and his unique identification code (UIC) is stored, the access to shared-use vehicles by using this unique identification code (UIC) is safe and easy. The system and method according to the invention allows to access shared-use vehicles by using a unique identification code (UIC), and, if this code is not known, to collect this unique identification code (UIC) by a very convenient system and method.

Various objects, features, aspects and advantages of the present invention will become more apparent from the following detailed description of preferred embodiments of the invention.

### BRIEF DESCRIPTION OF THE DRAWING

FIG. 1 illustrates one exemplary embodiment of a vehicle access control system.

FIG. 2 shows an overview of the exemplary system.

FIG. 3 shows an exemplary stored user profile.

FIG. 4 shows exemplary steps for making a reservation.

FIG. 5 shows exemplary Mode A to get vehicle access.

FIG. 6 shows exemplary Mode B to get vehicle access.

### DETAILED DESCRIPTION

From the point of view of an authorized user who wants to use a vehicle such as a car and make a reservation at a provider of shared-use vehicles, the procedure to make a reservation and use the vehicle, after becoming an authorized user, may comprise the following steps:

Step I: Making a reservation. This step comprises completion of a verification sequence, so the system can identify the user requesting a reservation. Usually the user owns a personal code (PC) or an account number, based on which the system is able to establish the user's personal code (PC). This step also comprises making a reservation for a specific vehicle, for example of one of a pool of vehicles parked in a specific location. This step also comprises making the reservation for a specific date, time and duration.

Step II: The driver goes to the specific location and gains access to the vehicle, uses the vehicle and afterwards returns the vehicle to a specific location. The access to the vehicle should be as convenient as possible, preferably by using a unique information code (UIC), for example provided by a chip chard, RFID tag, and/or by using a personal identification code (PIC).

Step III: The driver gets billed for the services used.

FIG. 1 illustrates an example of a vehicle-associated access control system 100. The system comprises a board computer 101 with memory 109, a card reader 105, door locks 107, a starter 106, an odometer 104, a display and keypad 108, a GSM-GPRS wireless modem 102 and an antenna 103. A communication link enables via GSM-GPRS wireless modem 102 and antenna 103 to exchange data between the board computer 101 and a remote server (not shown). If a communication link is enabled, reservation data may be transmitted from the remote server to the board computer 101 and/or data (e.g., the total distance traveled as measured by the odometer 104) may be transmitted to the server.

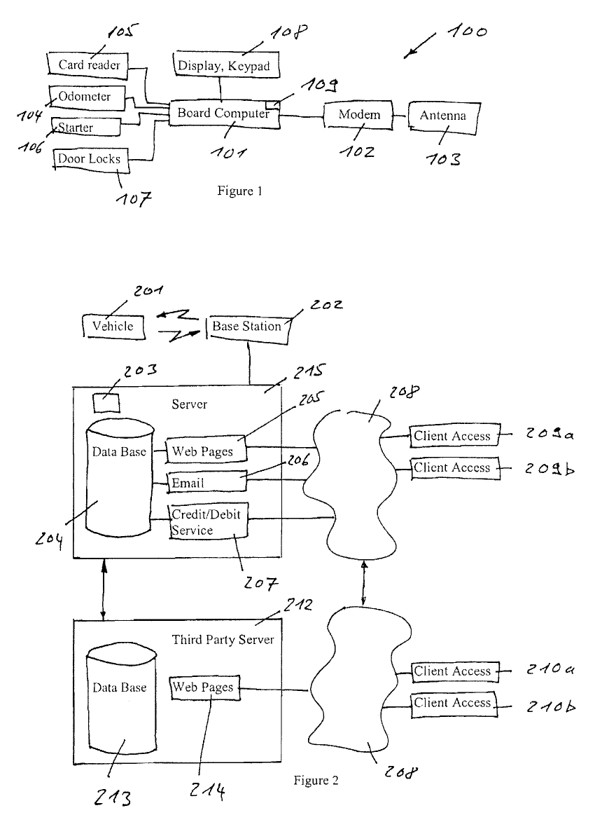

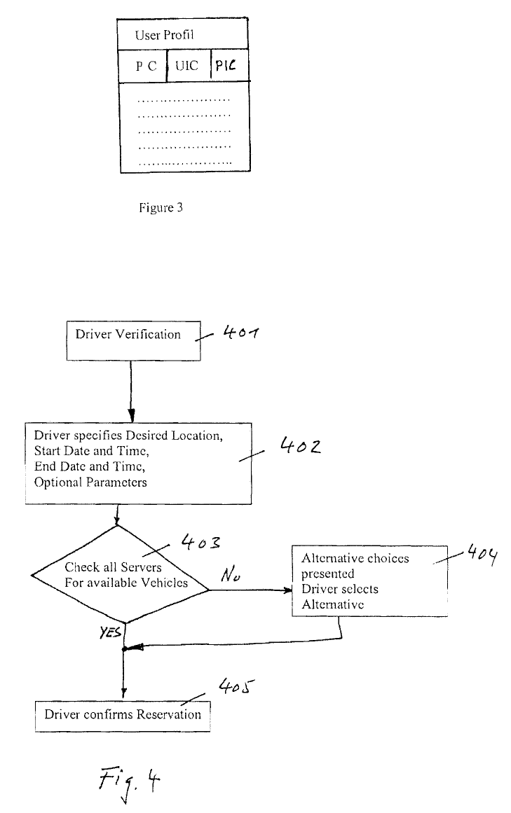

FIG. 2 illustrates one exemplary embodiment of the overall system of a shared-car provider. The vehicle-associated access control system 100 of FIG. 1 is contained in each of a plurality of cars 201 that communicate via wireless link through a base station 202 with a server 215. The client personal computers 209a and 209b are used to access the server 215 via communication network (e.g., Internet 208) so that vehicle availability can be reviewed and reservations created. Connection to the server 215 can also be provided with other types of connection like SMS, Bluetooth, etc. The server 215 contains a database 204 that stores all the information necessary to manage the resource management reservation system. Web pages 205 are provided by the server 215 using information from the database 204 and can be displayed on the client personal computers 209a and 209b via the Internet 208. The server 215 can also send and receive email via the Email In/Out module 206 and via the Internet 208. The server 215 has also access to a Credit/Debit service module 207, to automatically charge for usage of the cars. The server 215 comprises memory 203 to store a profile of each user.

FIG. 2 also illustrates a server 212 of a different service provider, a third party provider, herein called “partner-company”. The partner server 212 contains a database 213 that stores all information necessary to manage the independent partner resource management reservation system. Web pages 214 are provided by the partner server 212 using information from the database 213 and can be displayed on client personal computers 210a and 210b via the Internet 208. The clients personal computers 210a and 210b are also used to access the partner server 212 via the internet 208 so that vehicle availability can be reviewed and reservations created. To increase the usage of the cars 201, the company running server 215 and providing car sharing services, herein called “car-company”, may pool the cars with partner-companies, in that data of available cars are accessible for or transferred to the partner server 212. These data may include information such as type of car, price, date, time and location. Clients accessing the partner server 212 are therefore able to make reservations of cars 201 administered by the car-company.

Before enabling a new user to become an authorized user and to actually be in a position of making a reservation, the system of the car-company or of the partner-company verifies that the information submitted by a particular user is correct and acceptable. Depending on the level of security and credit verification desired, said verification could be more or less thorough. In a preferred embodiment, fully automated database queries are made from the server 215 or the server 212 to a remote entity responsible for regulating the use of the appropriate category of vehicles (e.g. driver's license). Upon confirmation that all information given is correctly correlated in the queried databases and/or is acceptable in relation to the service providers' system criteria, the new user becomes an authorized user, and for this authorized user a personal code (PC) or account number is generated at the server of the respective car-company or partner-company. The car-company and the partner-company usually provide different personal codes (PC, PC1), may be also in different formats and based on different rules.

As shown in FIG. 3, each user profile comprises at least a personal code (PC) and a unique identification code (UIC), whereby the unique identification code (UIC) need not be known at the time of creating the user profile, but can be collected later. Indeed, where the unique identification code comprises biometric data or an RFID signal, such data will not be known to the person making the reservation. The user profile may comprise further data, such as individual preferences of the user, like type of car and so on. The user profile may also comprise a personal identification code (PIC).

FIG. 4 describes the method to make a reservation according to Step I in more detail. The driver's identity is verified, as shown in step 401, by any of various means including entering a username and password. Once the driver's identity and account is accepted and his personal code (PC) has been identified, the driver then specifies the desired location to use the car, as well as start date and time, end date and time, and other optional parameters, shown in step 402. As shown in step 403, the server (215 or 212 of FIG. 2) checks for any available vehicle or vehicles that match the preferences specified. If necessary, various different servers, optionally of different providers, may be checked. If no vehicles are available that match the preferences, alternative choices are presented to the driver, as shown in step 404.

After the vehicle availability is confirmed, or an alternative vehicle is chosen, shown in step 404, the driver confirms the reservation, shown in step 405. The confirmation step allows the driver to select from among several available vehicles that match the preferences. After the reservation is confirmed, a reservation dataset is created and stored, the reservation dataset comprising at least data regarding desired location, start date and time, and including at least one of the personal code (PC) and unique information code (UIC). In this example it is assumed the unique information code (UIC) is the Chip-ID of a smart card.

When the reservation was made on the server of the car-company it may happen that the unique information code (UIC) of the user is not known, and therefore the reservation dataset created by the car-company does not comprise this unique information code (UIC). Therefore a typically temporary personal identification code (PIC) is provided to the user and is stored with the corresponding personal code (PC).

The car-company allows an authorized user access to a vehicle in two different modes:

Mode A: Access knowing the unique information code (UIC) of the user.

Mode B: Access without knowing the unique information code (UIC) of the user but using a personal identification code (PIC), and collecting the unique information code (UIC) of the respective user. Most preferably, the unique information code (UIC) is automatically collected (e.g., by acquisition of biometric information, swipe and/or proximity of a machine-readable card, etc.).

After the reservation is confirmed, received and stored in the server of the car-company, it is checked whether server establishes communication with the vehicle-associated access control module the appropriate car. Once this communication is established, the server transfers the reservation information to the vehicle-associated access control module. The information usually comprises specific renting data like desired location, start date and time, end date and time, optional parameters and also includes the unique information code (UIC) or chip ID of the user, or, if not available, a personal identification code (PIC).

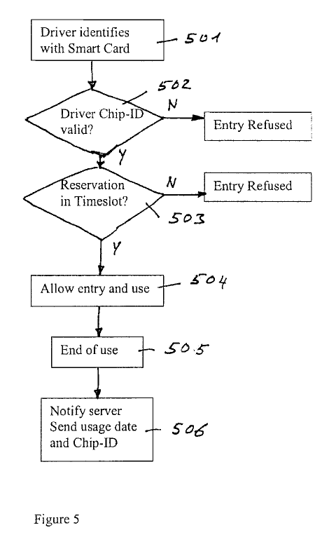

FIG. 5 describes access Mode A in more detail. In FIG. 5, the driver goes to the specific location and gains access to the vehicle. The operations shown in FIG. 5 are implemented by the vehicle associated access control module (100 of FIG. 1). As shown in step 501 of FIG. 5, the driver first identifies himself to the system with a smart card having a chip-ID. In the preferred embodiment, the access control module is equipped with a proximity card detector that enables access to the vehicle only when a validated proximity card is placed in proximity to the card detector. If the chip-ID in step 502 is valid and the provided unique information code (PUIC) corresponds to the unique information code (UIC) stored in the access control module, then in step 503 it is checked whether the actual time is within the timeslot the reservation has been made. If this criterion is fulfilled, entry and use is allowed in step 504. If appropriate, further security procedures such as entering an additional code could be applied, before opening the door or before starting the engine. After the end of using the vehicle 505, a dataset is sent to the server in step 506, this dataset including the chip-ID, and for example mileage.

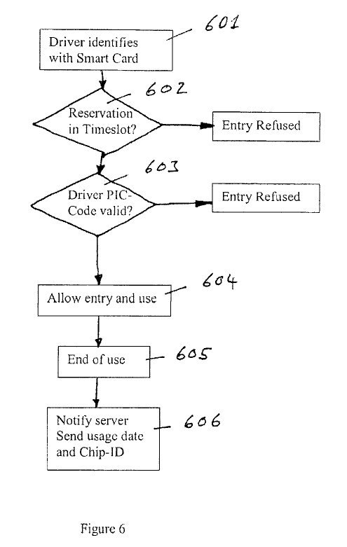

FIG. 6 describes access Mode B in more detail. In FIG. 6, the driver goes to the specific location and tries to gain access to the vehicle. The operations shown in FIG. 6 are implemented by the vehicle associated access control module. As shown in step 601 of FIG. 6, the driver first identifies himself to the system with a smart card having a chip-ID, which means the card reader tries to read a provided unique information code (PUIC). Alternatively, or additionally, other unique data can be automatically acquired (e.g., biometric data). If a chip-ID can be recognized and the provided unique information code (PUIC) can be read, then in step 602 is checked whether the actual time is within a reservation timeslot, within which an authorized user was expected. If this criterion is fulfilled the authorized user has to provide a personal identification code PPIC in step 603. If the provided PPIC corresponds to the personal identification code PIC expected with the specific authorized user, access to the vehicle is permitted in step 604 and the provided unique identification code PUIC is stored in memory (109 of FIG. 1 of the control module 100), preferably replacing the temporary PPIC. After the end of using the vehicle in step 605, a dataset is sent to the server in step 606, this dataset including the provided unique identification code PUIC, which is the chip-ID, as well as for example mileage and further data. Later on, the user profile of the specific authorized user in the reservation system is updated by storing the provided unique identification code PUIC as the unique identification code UIC. There are various ways in step 603 to key in the provided personal identification code PPIC. For example the vehicle-associated access control module comprises input means like a keypad 108, which is accessible from outside the vehicle. As an alternative, for example a mobile phone could be used to key in and send the provided personal identification code PPIC to the server, which transmits this code PPIC to the control module. As an alternative, access to the vehicle is allowed after succeeding step 602, and the control module comprises a keypad accessible within the vehicle, through which the code PPIC can be keyed in. Thus, it should be noted that systems and methods according to the inventive subject matter presented herein do not only allow users of the car-company to make reservations for vehicles, but also allow the user of partner-companies to make reservation of vehicles managed by the car-company.

As soon as the user of a partner-company has become an authorized user of the partner-company and has received a personal code (PC1) or an account number at the partner-company, the user may make a reservation in the server of the partner-company for cars managed by the car-company, specifying desired location, start date and time, end date and time and optional parameters. This data, including the personal code (PC 1) of the partner-company are then transferred to the server of the car-company. The car-company checks whether for the personal code PC1 already a user profile exists, as disclosed in FIG. 3. If a user profile exists, including a personal code (PC), the data received from server are stores in this user profile, including personal code PC1. If the user profile does not exist, a new user profile, including a personal code PC is created, and the data received from server, including personal code PC1, is stored in this user profile. When making a reservation for a car the partner-company is considered to be a trusted partner in that the partner-company is responsible for checking that all user information is correct, and in particular, that the user fulfills all legal requirements for driving a car.

If available, the partner-company also provides the unique identification code UIC. In this case, the unique identification code UIC may also be the personal code PC1. Usually the partner-company doesn't know the unique identification code UIC, and therefore is not able to provide this code. In this situation, the car-company provides a personal identification code (PIC) to the user, for example by E-mail or SMS, and uses Mode B, as described, to get access to the vehicle. By using Mode B, the unique information code (UIC) of the user is collected and stored in the user profile stored in the database of the car-company.

If, in the future, the same authorized user makes a reservation through the partner-company, the partner-company will provide, as usual, reservation data comprising the personal code PC1 of the respective user, which are transmitted to the server of the car-company. Because the car-company has stored the user profile, including the personal code PC1, PC and the respective unique identification code UIC, the vehicle-associated access control module 100 is provided with the unique identification code UIC, and the uses accesses the vehicle is Mode A. Therefore, even if the partner-company does not know the unique identification code UIC of the respective user, the car-company is able to find out the unique identification code UIC by Mode B access, and the car-company may afterwards for this specific user always use Mode A to access their vehicles. Further access to the vehicle may be gained, even though the car-company has only little information about the user, such as the personal code PC1, and later the unique identification code UIC. This is possible, because users from the partner-company are considered to be trusted users and do not have to be checked in detail.

If the reservation was made by a partner-company, the server (215 of FIG. 2) transfers at least the respective personal code PC1 as well as billing information to the server (212 of FIG. 2) of the partner-company, to provide them with all necessary information to charge their client. The car-company does not need detailed information about the user of the partner-company, except the personal code PC1, because the partner-company has all detailed information to charge the user.

This method allows for a user of a partner-company to very easily gain access to vehicles administered by the car-company. This method also allows for a user of a car-company to very easily gain access to vehicles administered by another car-company or another vehicle provider. The system and method according to the invention therefore allows a user to get access to a large amount of vehicles, which can be placed, depending on the participating car-companies, on many places on the world.

By using and knowing the unique identification code UIC, it is also possible to allow spontaneous access to a vehicle for users of the car-company as well as for users of partner-companies. Assuming a vehicle has no fixed reservation and a user is presenting his unique identification code UIC. Such a user could gain access to the vehicle by mode A, without the need of making a reservation, as explained with step I. After returning the vehicle, all information regarding charging is sent to server, and the user will be charged either by the car-company or by the respective partner-company. The concept of using a unique identification code and of getting the information about the unique identification code in possession of a lot of users, allows making the use of shared vehicles very easy, very convenient, and very reliable and safe.

Thus, specific embodiments and applications of vehicle access control have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A system for controlling access to a vehicle (201), comprising:
a vehicle-associated access control module (100) configured to enable access to the vehicle (201) by a first or a second authorized user following completion of a verification sequence, the vehicle-associated access control module (100) comprising a reader (105) for reading a provided unique information code (PUIC);
a server (215, 212) including a verification module (203), wherein the server is configured to execute a reservation for the vehicle (201) upon receiving a request to reserve the vehicle (201), the server further including a storage element (204, 213) for storing a unique information code (UIC) and a personal identification code (PIC) of the first and the second authorized user;
a communications channel (202) configured to support communication between the vehicle-associated access control module (100) and the server (215, 212);
wherein the vehicle-associated access control module (100) comprises a storage portion (109) configured to store information representative of the reservation, and comprises a decision module (101) configured to enable access to the vehicle (201);
wherein the decision module (101) is coupled to a reader (105) that is configured to read a provided unique identification code (PUIC);
wherein the decision module (101) is configured to check whether a unique identification code (UIC) of the first authorized user is stored, and is further configured to either:
(a) permit vehicle access to the first authorized user if the provided unique identification code (PUIC) corresponds to the unique identification code (UIC) of the first authorized user; or
(b) read via an input device (105, 108) a provided personal identification code (PPIC) and permit access if the provided personal identification number (PPIC) corresponds to the personal identification code (PIC) of the first authorized user, wherein the decision module (101) is further configured to transmit the provided unique identification code (PUIC) via the communication channel (202) to the server (215); and
wherein the provided unique identification code (PUIC) is stored in the storage element (204) as the unique identification code (UIC) of the first authorized user.

2. The system of claim 1, wherein the reader (105) comprises a chip card detector.

3. The system of claim 2, wherein the reader (105) is configured to detect a chip ID.

4. The system claim 1, wherein the decision module (101) comprises a timer that is configured to enable access to the vehicle (201) for an authorized user only within a predetermined timeframe.

5. The system of claim 1, wherein the verification module (203) is configured to monitor whether for an authorized user a respective unique information code (UIC) is stored, and is further configured to ascertain that, if available, the unique information code (UIC) is transmitted to the vehicle-associated access control module (100).

6. The system of claim 1, wherein the verification module (203) is programmed to select, based on a personal code (PC, PC1), the corresponding unique information code (UIC), and is programmed that in the communication with a third party the personal code (PC, PC1) is used.

7. A method of controlling access to a vehicle (201) by a first or second authorized user, characterized in that the method comprises:
making at a reservation system (212,215) a reservation for the vehicle (201) upon receiving a request by the first authorized user to reserve the vehicle (201), wherein the reservation system (212,215) stores information of authorized users;
checking whether information of authorized users comprises a unique identification code (UIC) of the first authorized user (U1), and if not, transmitting a personal identification code (PIC) to the first authorized user (U1);
wherein the first authorized user (U1) attempts to access to the vehicle (201) by providing a unique identification code (PUIC); and
either permitting access if the provided unique identification code (PUIC) corresponds to the unique identification code (UIC) of the first authorized user (U1);
or collecting the provided unique identification code (PUIC) and updating the stored information of the first authorized user (U1) in the reservation system (212,215) by storing the collected data as the unique identification code (UIC), and permitting access if the first authorized user (U1) provides a personal identification code (PPIC) corresponding to the transmitted personal identification code (PIC).

8. The method of claim 7 wherein, if the first authorized user (U1) provides a personal identification code (PPIC) corresponding to the transmitted personal identification code (PIC), access is only permitted if the first authorized user (U1) provides the personal identification code (PPIC) within a predetermined timeframe.

9. The method of claim 7, wherein providing a unique identification code (PUIC) comprises a step of reading a chip ID of a chip card.

10. The method of claim 7, wherein, if the request by the first authorized user (U1) to reserve the vehicle (201) does not comprise a unique identification code (UIC), stored data are checked, and if available, the stored unique identification code (UIC) of the first authorized user (U1) is chosen to be the unique identification code (UIC) of the first authorized user (U1).

11. The method of claim 7, wherein the step of making a reservation for the vehicle (201) and storing information of an authorized user comprises data about desired location, start date, start time, and personal code (PC).

12. The method of claim 11, wherein a third party makes a reservation for the vehicle (201) by providing data about desired location, start date, start time and personal code (PC1).

13. The method of claim 12 further comprising a step of sending billing information to the third party using the personal code (PC1) as reference.

14. A method of providing access to a vehicle, comprising:
using a processing device to assign a first identification information to a user to allow access to a vehicle having an remote access control module that communicates with the processing device;
acquiring the first identification information and a second identification information from a person using the remote access control module and transmitting the first and second identification information to the processing device; and
re-assigning access allowance by replacing the first identification information with the second identification information.

15. The method of claim 14, wherein the user communicates with the processing device via Internet or telephone to make a reservation for the vehicle.

16. The method of claim 14, wherein the first identification information is a password and wherein the step of acquiring the first identification information comprises entering the password via a keypad.

17. The method of claim 14, wherein the second identification information is a signal from an electronic device, and wherein the step of acquiring the second identification information comprises approximating or contacting the access control module with the electronic device.

18. The method of claim 17, wherein the electronic device comprises a card comprising a microchip or an radiofrequency identification tag.

19. The method of claim 14, wherein the user and the person are identical.

20. The method of claim 14, wherein the user is a third party, and wherein the third party receives information about access to the vehicle by the person, and is optionally billed for use of the vehicle by the person.
